(19) United States
(12) Patent Application Publication
(10) Pub. No.: US 2021/0156190 A1
(43) Pub. Date: May 27, 2021

(54) Sealing Tape

(71) Applicant: ISO-Chemie GmbH, Aalen (DE)

(72) Inventor: Martin Deiss, Abtsgmuend (DE)

(73) Assignee: ISO-Chemie GmbH, Aalen (DE)

(21) Appl. No.: 17/100,624

(22) Filed: Nov. 20, 2020

(30) Foreign Application Priority Data
Nov. 22, 2019 (EP) 19 210 886.8

(51) Int. Cl. E06B 1/62; E04B 1/68; E06B 7/23

(52) U.S. Cl. CPC E06B 1/62; E06B 2001/626; E06B 7/23; E04B 1/6812

(57) ABSTRACT

The sealing tape comprises at least one base body of flexible foam capable of recovery after compression. In the area of the bottom surface of the sealing tape, an adhesive layer for bonding to a frame profile of a window or door is arranged. The sealing tape comprises a continuous barrier structure for reducing the permeability to the diffusion of water vapor and/or the permeability to air in the functional direction of the sealing tape, which barrier structure begins from at least one side surface and extends along the top surface to an area between the side surfaces, from where it then proceeds from the top surface to the bottom surface, and finally extends along a bottom surface of the at least one base body from the area between the side surfaces to at least one side surface.

### FIELD OF THE INVENTION

The present invention relates to a sealing tape with at least one base body of flexible foam capable of recovery after compression.

In general, sealing tapes serve to seal joints between structural components, especially between the frame profiles of windows or doors and the wall of a building.

An example of this type of sealing tape is known from EP 3 513 954 A1. The sealing tape comprises a foam carrier, into which cuts proceeding in alternation from the top surface and from the bottom surface are made. A film strip, an adhesive tape strip, or an adhesive-like medium is introduced into each of these cuts. In one embodiment, an additional, a V-shaped cut is made in a surface opposite each of the cuts in question so that the two cuts are aligned with each other; an additional film element can be inserted into this additional cut to form a continuous film element.

### SUMMARY OF THE INVENTION

It is an object of the present invention to provide a sealing tape, the sealing properties of which can be adjusted easily and effectively and which can be produced easily and at low cost.

According to an aspect of the invention, the sealing tape comprises at least one base body of flexible foam capable of recovery after compression, wherein the sealing tape comprises a top surface, a bottom surface, and a first and a second side surface, which connect the top surface and the bottom surface to each other, wherein the side surfaces are substantially perpendicular to a functional direction of the sealing tape. An adhesive layer is arranged in the area of the bottom surface, so that the sealing tape can be adhered to a building component, in particular to the frame profile of a window or door. The sealing tape comprises a continuous barrier structure to reduce the permeability to water vapor diffusion and/or the permeability to air in the functional direction, which barrier structure begins from at least one of the two side surfaces and extends along the top surface of the sealing tape to an area between the first and second side surfaces, from where it proceeds to the bottom surface of the sealing tape and then extends along the bottom surface of the at least one base body from the area between the first and second side surfaces to at least one of the two side surfaces, i.e., to the first and/or to the second side surface.

In this way a sealing tape is produced which can be obtained easily and at low cost and in particular without the need to introduce individual elements of the continuous barrier structure laboriously into cuts in a foam body.

Through the selection of a suitable material for the barrier structure, the sealing properties of the sealing tape with respect to the water vapor diffusion permeability and/or the air permeability of the sealing tape can be effectively adjusted. Thus the functionality of the sealing tape is expanded, wherein sensitive parts of the barrier structure are protected from damage by external influences during transport or handling. The barrier structure preferably lines up precisely with the side surfaces.

In one embodiment, the barrier structure extending along on the top surface begins from the first side surface and proceeds to the area between the first and second side surfaces, from which it then proceeds from the top surface to the bottom surface of the sealing tape and finally extends along the bottom surface of the at least one base body from the area between the first and second side surfaces to the second side surface. As a result, a continuous barrier structure can be formed, and at the same time the required amount of barrier structure material can be reduced, because this material needs to be provided only in certain areas and does not have to extend over the entire width of the sealing tape on the top surface of the sealing tape and over the entire width along the bottom surface of the sealing tape.

In another embodiment, these advantages can also be achieved in that the barrier structure extending along the top surface begins from the first side surface and proceeds to the area between the first and second side surfaces, from which it then proceeds from the top surface to the bottom surface of the sealing tape and finally extends along the bottom surface of the at least one base body from the area between the first and second side surfaces to the first side surface. The variety of possible embodiments and production variants is thus also increased, which means that the sealing tape can be adapted more easily to the requirements of a specific situation.

In preferred embodiments, the barrier structure extends over the entire top surface of the sealing tape. A sealing tape according to the invention such as this is especially easy to produce in another embodiment, in which the barrier structure extending along the top surface begins from the first and second side surfaces and proceeds to the area between the first and second side surfaces, from which it then proceeds from the top surface to the bottom surface of the sealing tape and finally extends along the bottom surface of the at least one base body from the area between the first and second side surfaces to the first side surface and to the second side surface.

Embodiments are also conceivable in which the barrier structure extending along the top surface begins from the first and second side surfaces and proceeds to the area between the first and second side surfaces, from which it then proceeds along the bottom surface of the at least one base body from the area between the first and second side surfaces only to the first or only to the second side surface. Alternatively, the barrier structure on the top surface can begin only from the first or only from the second side surface and proceed to the area between the first and second side surfaces, from which it then proceeds along the bottom surface of the at least one base body from the area between the first and second side surfaces to the first and to the second side surface.

The top surface of the sealing tape preferably comprises a profile with at least one valley, such that the sealing tape, in a fully expanded state, comprises a first thickness in the area of the first side surface, a second thickness in the area of the second side surface, and a third thickness in the area between the first and second side surfaces which is less than the first thickness and less than the second thickness. In the fully expanded state of the sealing tape, the interior space of the valley is filled exclusively with air. The barrier structure now proceeds from the top surface to the bottom surface in such a way that it extends through the area of the third thickness. The sealing tape thus formed can be produced especially easily and cheaply. The air-filled valley, furthermore, has a positive effect on, for example, the thermal insulation achievable by the sealing tape.

The interior space of the valley is defined here as the space which is bounded by a curved section of the top surface of the sealing tape in the area of the valley and an imaginary extension, proceeding over the curved area, of a flat section of the top surface of the sealing tape near a side surface.

The thickness of the sealing tape is defined in a direction which extends between the top surface and the bottom surface of the sealing tape and which is perpendicular to the functional direction of the sealing tape and preferably parallel to the side surfaces.

In a preferred embodiment, the first and second thicknesses are substantially the same.

As a result, the pressure exerted by the sealing tape on the building wall is the same at both side surfaces.

In a preferred embodiment, the third thickness is between 2 and 95%, more preferably between 3 and 80%, even more preferably between 5 and 50%, of the first thickness.

In all embodiments, the first thickness and/or the second thickness of the sealing tape in the fully expanded state is preferably between 5 and 150 mm, more preferably between 10 and 100 mm.

In all embodiments, the third thickness of the sealing tape in the fully expanded state is preferably between 1 and 142 mm, more preferably between 2 and 95 mm.

In a preferred embodiment of the sealing tape, the area of the third thickness is arranged substantially in the middle between the two side surfaces.

The valley preferably extends over an area of 2-60%, more preferably over an area of 5-40%, of the entire width of the sealing tape.

The width of the sealing tape in all embodiments is preferably between 10 and 500 mm, more preferably between 10 and 150 mm. The width of the sealing tape is defined as the distance between the side surfaces of the sealing tape in a direction parallel to the functional direction.

A bottom of the at least one base body can, in the fully expanded state of the sealing tape, be flat. In the fully expanded state of the sealing tape, the bottom of the at least one base body can also, however, comprise a profile with a bottom valley, which is oriented toward the top surface of the sealing tape and which is opposite the valley in the top surface in the area of the third thickness.

In the fully expanded state of the sealing tape, the adhesive layer can then comprise a profile with the shape of a hill and thus conform substantially to the shape of the bottom valley. In the latter case, the adhesive layer is preferably adhered substantially continuously along the bottom surface of the sealing tape to adjacent areas of the sealing tape.

Independently of the profile of the bottom of the at least one base body, the adhesive layer in certain embodiments will be flat in the fully expanded state of the sealing tape. In this case, it can be effective for the adhesive layer to be adhered at its top surface to the adjacent areas of the sealing tape only in areas adjacent to the side surfaces of the sealing tape. It is conceivable that the adhesive layer could have adhesive properties in the upward direction only in the areas in which it comes in contact with areas of the sealing tape. The adhesive layer can, for example, be applied to the sealing tape afterwards, as a separate strip.

In all cases, the adhesive layer is preferably configured as a double-sided adhesive tape. In general, the adhesive surface of the adhesive layer serving to attach the sealing tape to the building component is oriented downward, i.e., facing away from the base bodies, and can be covered by a peel-off film or peel-off paper, which can be removed before use.

The lesser third thickness in the fully expanded state of the sealing tape is preferably achieved at least in part by a permanent compression and/or fusion of the foam of the at least one base body. Although not absolutely necessary, it is then especially preferred that the barrier structure be formed in part by a permanently compressed and/or fused section of the at least one base body. Part of the barrier structure can therefore be easily produced during the process of compression/fusion. As a result of the compression/fusion of the at least one base body, not only is the desired surface profile of the sealing tape produced but also an additional sealing action is obtained.

Each of the above-described embodiments can comprise precisely one, preferably integral, base body of flexible foam. The embodiments can also, however, comprise two or more base bodies, which are arranged next to each other in the functional direction of the sealing tape. Independently of the number of base bodies, the sealing tape can also comprise several lower and/or upper valleys, which are arranged next to each other in the functional direction.

In a preferred embodiment, the sealing tape comprises at least two base bodies of flexible foam, which are arranged next to each other in the functional direction of the sealing tape, wherein the barrier structure, in a transition area between the two adjacent base bodies, proceeds at least part of the way from the top surface to the bottom surface of the sealing tape.

If the sealing tape has an area with the third thickness, this area is preferably positioned in the transition area between the base bodies. The lesser third thickness can then be achieved by, for example, the permanent compression of one of the base bodies near the transition area to the adjacent base body. Alternatively, the lesser third thickness can also be obtained by a permanent compression of two adjacent base bodies near the transition area between the two base bodies.

The at least two base bodies are preferably configured originally as separate units. As a result, it is possible to form the two base bodies out of different foam materials and therefore to easily influence the sealing and insulating properties of the sealing tape. The two base bodies, however, can also be made out of the same type of foam.

The at least two base bodies can be adhered to each other exclusively via the adhesive layer on the bottom surface. The at least two base bodies, however, are preferably adhered permanently to each other, either additionally or alternatively, in the transition area, e.g., by means of the barrier structure or an additional adhesive layer between the base bodies. In this way, the sealing tape acquires greater stability. The barrier structure is then preferably formed in part by an adhesive layer of this type. The thickness of such an adhesive layer in the transition area in the fully expanded state of the sealing tape is preferably is 2-80%, more preferably 3-60%, especially preferably 5-50% of the first thickness.

In a preferred embodiment, the barrier structure is configured as a continuous, preferably one-piece, barrier layer, which, on the top surface of the sealing tape, extends along the top surface of at least one of the at least two base bodies, then proceeds from the top surface to the bottom surface of the sealing tape, and finally extends along the bottom surface of at least one of the at least two base bodies. The continuous barrier layer preferably extends from the top surface to the bottom surface of the sealing tape between two adjacent base bodies.

In an alternative embodiment, at least one base body comprises a covering, which surrounds the base body on the top surface, the bottom surface, and a side facing an adjacent base body. It is especially preferred that the covering form a part of the barrier structure or the entire barrier structure.

In one embodiment given by way of example, the sealing tape comprises precisely two base bodies, both of which comprise a corresponding covering.

If it is desired to compress the one base body or the two base bodies near the transition area, this is preferably achieved or supported in each case by the use of the covering. In many embodiments, however, no significant compression of the base bodies near the transition area is provided.

In one embodiment, at least one base body comprises a first leg of the base body which is bent over by 180° versus a second leg of the base body, wherein the bending site is arranged in the transition area to the other base body. The first and second legs are preferably adhered to each other along their facing surfaces; it is especially preferable that they be adhered by the use of an adhesive or by means of lamination. In this embodiment as well, the base body in question can comprise a covering, as previously described.

The foam material of a base body of this type is preferably compressed into itself in the area of the bending site by the effect of the bending.

In preferred embodiments, the covering comprises substantially closed-cell flexible foam or consists of it. This offers the advantage that the flexible foam rests especially elastically against the building wall, and thus the formation of air channels and/or water vapor diffusion channels between the sealing tape and the building wall is avoided. The covering, however, can also be made of other appropriate materials.

Independently of how many base bodies the sealing tape comprises, the barrier structure, in a preferred embodiment, is formed in part by a barrier layer arranged on the top surface of the at least one base body.

The barrier layer arranged on the top surface of the at least one base body preferably comprises substantially closed-cell flexible foam or consists of such foam to guarantee the seal-producing contact of the top surface of the sealing tape with the building wall.

In embodiments with a lesser third thickness, it is also preferred that the barrier layer arranged on the top surface of the at least one base body be permanently compressed and/or fused in the area of the third thickness of the sealing tape. This is advantageous especially in cases where the permanent compression and/or fusion of this barrier layer occurs jointly with the compression and/or fusion of the material of the base body during the production process.

It is also preferred that the barrier structure be formed in part by a barrier layer arranged on the bottom surface of the at least one base body.

This barrier layer can be formed by the adhesive layer arranged in the area of the bottom surface, or it can comprise substantially closed-cell flexible foam or consist of such foam.

Especially in this case but also in other embodiments as well, the barrier structure can be formed in part by the adhesive layer arranged in the area of the bottom surface.

Also in the case of a bottom barrier layer, it is preferred in embodiments with a lesser third thickness that the barrier layer arranged on the bottom surface of the at least one base body be permanently compressed and/or fused in the area of the third thickness of the sealing tape. This is especially advisable in cases where the compression or fusion carried out during a production step occurs jointly with the compression and/or fusion of the material of the base body and/or the compression and/or fusion of a barrier layer arranged on the top surface of the sealing tape.

The compression and/or fusion of the base body, preferably also the compression and/or fusion of the barrier layer on the top surface, even more preferably also the compression and/or fusion of the barrier layer on the bottom surface, are carried out by means of adhesive bonding, stitching, lamination, or surface-fusing. In this way, it is possible to arrive at the permanent compression and/or fusion without the need to provide for this purpose additional elements in the area of the valley in the top surface of the sealing tape. All of the above-mentioned methods of compression and/or fusion can be carried out simultaneously, i.e., in a single work step, for all of the individual layers lying on top of each other.

In the fully expanded state of the sealing tape, the thickness of the permanently compressed and/or fused section consisting of all the layers participating in a particular configuration is in general preferably 2-50%, more preferably 3-40%, especially preferably 5-30%, of the first thickness.

For the purpose of increasing the ease of handling and transport and also of reducing the amount of space required for storage, the sealing tape according to the invention is preferably provided in the form of a sealing tape roll. The sealing tape in the sealing tape roll is in a compressed state in which the top surface and the bottom surface of the sealing tape extend in substantially straight lines. The sealing tape is wound up into the sealing tape roll in such a way that the bottom surface of the sealing tape of one turn rests against the top surface of the sealing tape of an adjacent turn, and the side surfaces of the sealing tape form the end surfaces of the sealing tape roll. If the top surface and/or the bottom surface of the sealing tape in the fully expanded state has a valley, this will be much less pronounced in the state in which the sealing tape has been wound up into a roll than it is in the fully expanded state.

The degree of compression of the first and/or second side surface in the compressed state on the sealing tape roll is preferably between 3 and 50%, more preferably between 5 and 25%, in comparison to the fully expanded state. The degree of compression designates here the thickness in the compressed state as a percentage of the thickness in the fully expanded state.

In an installed state, the sealing tape is arranged in a section of a building. The building section comprises a wall and a building component inserted into an opening in the wall, wherein the sealing tape is arranged in the joint between the building component and the wall and thus seals the joint. One of the side surfaces of the sealing tape faces the interior of the room, the other the exterior of the room, and the sealing tape is preferably connected to the building component by means of the adhesive layer in the area of the bottom surface of the sealing tape. In comparison to the uncompressed or fully expanded state of the sealing tape, the sealing tape in the installed state is partially compressed.

In this partially compressed installed state, it is preferable for the top surface of the sealing tape to rest against the wall in the area of the side surfaces of the sealing tape, whereas the top surface of the sealing tape does not rest against the wall at least in the area of the original third thickness, or possibly it rests against the wall in this area, where, however, it exerts a pressure which is less than that present in the area of the side surfaces of the sealing tape. This result is achieved primarily by the lesser third thickness of the sealing tape in the fully expanded state.

The degree of compression of the first and/or second side surface in the partially compressed, installed state is preferably between 5 and 90%, more preferably between 10 and 70%, compared to the fully expanded state. The degree of compression designates here the thickness in the partially compressed state as a percentage of the thickness in the fully expanded state.

The foam of the sealing tape can be made out of any desired open-cell or mixed-cell flexible foam. For example, it can be made of polyurethane, polyethylene, polyvinyl chloride, polyolefin, or polypropylene. The density of flexible foams of this type is between 15 and 200 kg/m³.

The foams described herein can also be configured in such a way that they comprise a skin on an exterior surface. This pertains both to the at least one base body of flexible foam and to the barrier structure which comprises a closed-cell foam or consists of such foam. A skin such as this is an integral part of the foam in question but has better sealing properties than the rest of the foam and can protect the rest of the foam from external influences. For example, the skin can be responsible for making the foam substantially water-tight. In spite of this, the foam still has the necessary flexibility to allow the best-possible contact with the surface of a wall. An appropriate skin formation on at least one surface, i.e., the top surface, bottom surface, or side surface, of the at least one base body can therefore form optionally a part of the barrier structure. The skin can be produced as early as the production of the foam in question. But the skin can also be formed at a later time, e.g., during the application of additional components, such as during the lamination of the closed-cell foam of the barrier structure to the at least one base body. A skin can be formed especially effectively on foam made of polyurethane.

When several base bodies are present, the individual base bodies of the sealing tape preferably consist of the same material. Alternatively, the individual base bodies can be made of different materials.

It is also possible to arrange more than two base bodies next to each other.

To delay its recovery, the at least one base body is preferably impregnated at least partially, preferably completely, with an impregnation agent. The impregnation agent preferably comprises an acrylate dispersion. In an advantageous embodiment, the acrylate dispersion comprises acrylate polymer particles dispersed in a homogeneous phase. It is especially preferred that the foam of the base body be impregnated with an acrylate dispersion for delayed recovery in a percentage by weight such that the sealing tape, at 20° C. and 50% relative humidity, shows a recovery in less than 24 hours from a degree of compression of the sealing tape of approximately 9-13% to the point at which it closes the joint.

The air permeability of the flexible foam of the at least one base body is preferably between 50 and 1,000 l/(m²s), more preferably between 60 and 600 l/(m²s), and especially preferably between 80 and 400 l/(m²s). All of the data on air permeability given within the scope of this application refer to a determination under the standard conditions according to DIN EN ISO 9237:1995, namely, on the basis of a 10-mm-thick foam piece (fully expanded) at a negative measurement pressure of 1.0 bar, with a test area of 100 cm², and with the use of a model 21443 Frank test device.

The flexible foam of the at least one base body preferably comprises a compression hardness of more than 2 kPa. The compression hardness is preferably more than 2.1 kPa, more preferably more than 2.2 kPa, especially preferably more than 2.3 kPa. The compression hardness is preferably less than 4 kPa, preferably less than 3.8 kPa, and more preferably less than 3.6 kPa. The compression hardness is a measure of the strength of the foam. The values given here are based on a compression of 40% versus the original thickness. The compression hardness is determined according to DIN EN ISO 3386:2015; the CV40 value is stated.

The properties and relationships explained in the following for the barrier layer or the covering apply generally to the barrier structure described herein in any of its many embodiments.

It is especially preferred that each barrier layer or covering comprise an substantially closed-cell flexible foam or that it be made exclusively of such foam. The closed-cell foam is preferably not impregnated. The term “closed-cell foam” is used within the scope of this application to mean a flexible foam comprising a high percentage of closed cells or of cells with only a small open cross section. A closed-cell foam is characterized exclusively by the indication of its air permeability. The air permeability of the closed-cell foam in the preferred embodiments is no more than 50 l/(m²/s), more preferably no more than 401/(m²/s), even more preferably no more than 30 l/(m²/s), and especially preferably no more than 20 l/(m²/s), measured according to DIN EN ISO 9237:1995 with a test area of 100 cm² at a measurement pressure (negative pressure) of 1.0 mbar by means of a model 21443 Frank test device.

Each barrier layer or covering described within the scope of this application can also be made of a film-like material or of an adhesive, in particular of a strip of film, a strip of adhesive tape, or an adhesive-like liquid medium. More concretely, each of the barrier layers or coverings described herein can be made of a film of polyamide, polyurethane, polypropylene, or copolymers thereof. Each barrier layer or covering can also be made of a dispersion adhesive, in particular an acrylate adhesive, or of some other appropriate adhesive material.

In all of the embodiments, each barrier layer or covering can have a multi-ply configuration consisting, for example, of any desired combination of several of the above-mentioned materials. It can also comprise, for example, a membrane layer and/or a layer of nonwoven material. In particular, each barrier layer or covering can be formed as a multi-ply composite layer. At least one layer of at least one additional material can be arranged on one or both sides of the functional layer. The one or both additional layers, each of which covers the functional layer partially or completely, can protect and carry or support the functional layer and increase the stability of the barrier layer or covering. The individual layers can consist of the same or different materials.

The layers arranged on one or both sides can in particular be nonwovens, fabrics, or meshes of inert substances such as polyethylene, polyurethane, polypropylene, polyester, glass fibers, or viscose, possibly also perforated films, especially those of polyethylene, polyurethane, polypropylene, or polyester. The layers can, in general, consist of any appropriate material which is present in the form of layers and which preferably does not have an sD value higher than that of the functional layer. The layers on one or both sides can consist of a dispersion adhesive, especially an acrylate adhesive.

If a top and a bottom barrier layer are present, these can be made of the same material or of different materials. Each barrier layer or covering can also consist of various sections of different materials.

All of the above-mentioned materials for the barrier layer or covering can be applied to the flexible foam of each base body and bonded to it in an especially simple and easy-to-control manner. In addition, these materials are especially effective as barrier structure material, because their sealing properties can be effectively fine-tuned.

Each barrier layer or covering has a thickness of 1 μm to 5 mm, preferably of 10 μm to 3 mm, and especially preferably of 50 μm to 2 mm.

Within the scope of the invention, each barrier layer or covering can, in general, form preferably a continuous, nonporous, and nonperforated layer. The air permeability of each barrier layer or covering is preferably in the range of 0.01-50 l/(m²s), more preferably in the range of 0.01-20 l/(m²s). The air permeability is preferably ≤3-61/(m²s) or preferably ≤1-2 l/(m²s) or ≤0.2-0.5l/(m²s) or especially preferably ≤0.1-0.3 l/(m²s) as determined according to DIN EN ISO 9237:1995 for a test area of 100 cm² at a measurement pressure (negative pressure) of 1.0 mbar with a model 21443 Frank test device, or is no longer measurable.

The characteristic value for the resistance of a sealing tape to the diffusion of water vapor is the water vapor diffusion value, the so-called sD value, based on a layer of air with a thickness measured in meters. Each barrier layer or covering preferably has an sD value of 0.02 m to 100 m, more preferably of 0.1 m to 25 m, or of 0.2 m to 15 m (at 25% relative humidity (RH)). The sD value is tested according to DIN EN ISO 12572:2001. Independently of this or in combination with it, each barrier layer or covering can have an sD value of 0.02 m to 10 m or of 0.03 m to 6 m or of 0.05 m to 2 m at 72.5% RH, measured according to DIN EN ISO 12572:2001. For example, the sD value at 25% RH can be in the range of 1-10 m, and at 72.5% RH it can be in the range of 0.1-5 m. Unless otherwise specified in DIN EN ISO 12572:2001, the sD values are based on a temperature of 20° C.

Each barrier layer or covering can also be configured with “humidity-related variability”; that is, its resistance to the diffusion of water vapor changes as a function of the humidity of the environment of the barrier layer.

The following relationships apply to every sealing tape according to the invention. The key factor with respect to the air permeability of a sealing tape section is, in general, the overall reduction of the air stream in one direction over the entire cross section of the sealing tape section. If, for example, in the thickness direction or in the functional direction of the sealing tape, a plurality of barrier structure sections and base bodies are arranged in alternation, the reduction of the air stream through all these barrier structure sections and base bodies is to be taken into account. The air permeability of the overall sealing tape in the functional direction is preferably less than 50 l/(m²s), more preferably less than 40 l/(m²s), more preferably less than 30 l/(m²s), more preferably less than 20 l/(m²/s), more preferably less than 10 l/(m²s), more preferably less than 5 l/(m²s), under the above-indicated measurement conditions.

In one embodiment, the sealing tape also comprises an additional material, which is applied to surface of the at least one base body and/or to a barrier layer or covering and/or is contained in the impregnation agent of the at least one base body. The additional material can give the sealing tape special properties. Additional materials which can be considered in particular include, for example, materials for fire protection (e.g., expandable graphite, noncombustible solids, CO₂ emitters, etc.), insulating materials (e.g., polyurethane foam, resins, sealants, etc.), materials for sealing off against moisture (e.g., hydrophobic or hydrophilic substances, substances which swell on contact with water, etc.), materials for sound damping, materials for controlled venting (e.g., catalysts, etc.), materials for hygienic purposes (e.g., disinfectants, etc.), and/or materials for initiating the expansion of the sealing tape (e.g., propellants, heat sources, etc.). The skilled person will be familiar with alternatives for both the arrangement and the type and properties of the additional material which can be used to fulfill the requirements in a concrete case.

### BRIEF DESCRIPTION OF THE DRAWINGS

FIG. 1 is a schematic, cross-sectional view of a first embodiment of a sealing tape according to the invention in the fully expanded state;

FIG. 2 is a schematic, perspective view of the sealing tape according to FIG. 1 after it has been wound up into a sealing tape roll;

FIG. 3 is a schematic, cross-sectional view of a second embodiment of the sealing tape according to the invention in a fully expanded state;

FIG. 4 is a schematic, cross-sectional view of another embodiment of the sealing tape according to the invention in a fully expanded state;

FIG. 5 is a schematic, cross-sectional view of another embodiment of the sealing tape according to the invention in a fully expanded state;

FIG. 6 is a schematic, cross-sectional view of another embodiment of the sealing tape according to the invention in a fully expanded state;

FIG. 7 is a schematic, cross-sectional view of another embodiment of the sealing tape according to the invention in a fully expanded state;

FIG. 8 is a schematic, cross-sectional view of another embodiment of the sealing tape according to the invention in a fully expanded state;

FIG. 9 is a schematic, cross-sectional view of another embodiment of the sealing tape according to the invention in a fully expanded state;

FIG. 10 is a schematic, cross-sectional view of another embodiment of the sealing tape according to the invention in a fully expanded state;

FIG. 11 is a schematic, cross-sectional view of an installation situation of the sealing tape according to FIG. 1, in which the sealing tape, in a partially compressed installation state, is arranged in a joint between a building component and a wall with a sealing action; and

FIG. 12 is a schematic, cross-sectional view of an installation situation of the sealing tape according to FIG. 8, in which the sealing tape, in a partially compressed installation state, is arranged in a joint between a building component and a wall with a sealing action.

### DETAILED DESCRIPTION OF SPECIFIC EMBODIMENTS

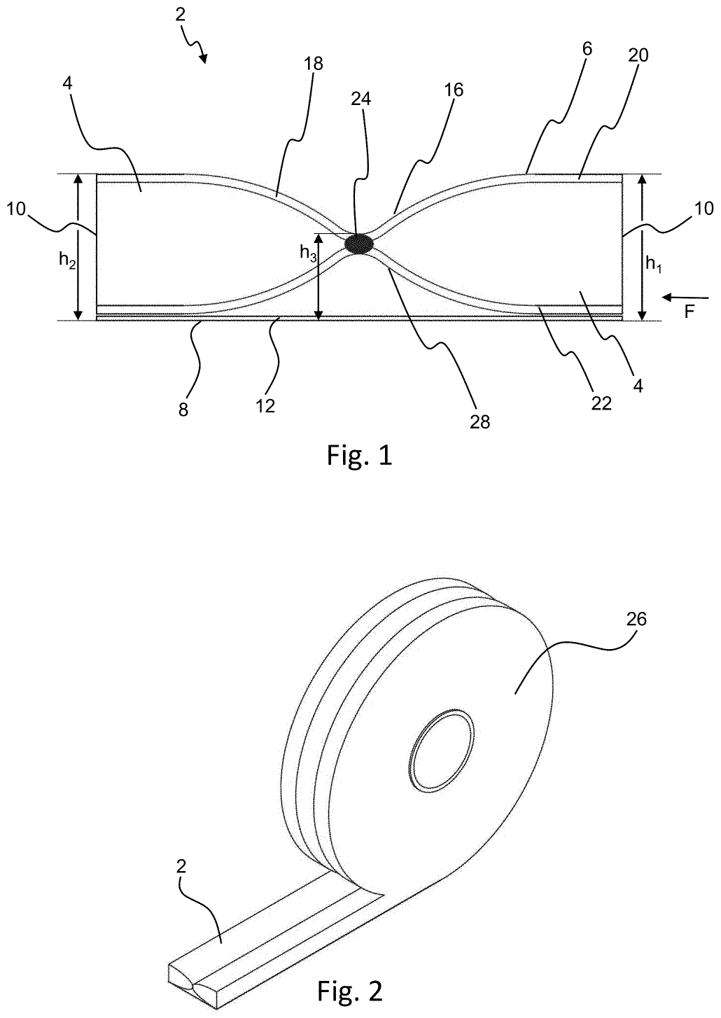

The sealing tape 2 shown in cross section in FIG. 1 comprises a base body 4 of flexible foam, which is capable of recovering after being compressed, and which is preferably impregnated to delay its recovery. The base body 4 originally has a one-piece shape, but, as a result of a permanent compression and/or fusion of the material of the base body 4, it is thinner in the middle area than in the areas to the right and to the left.

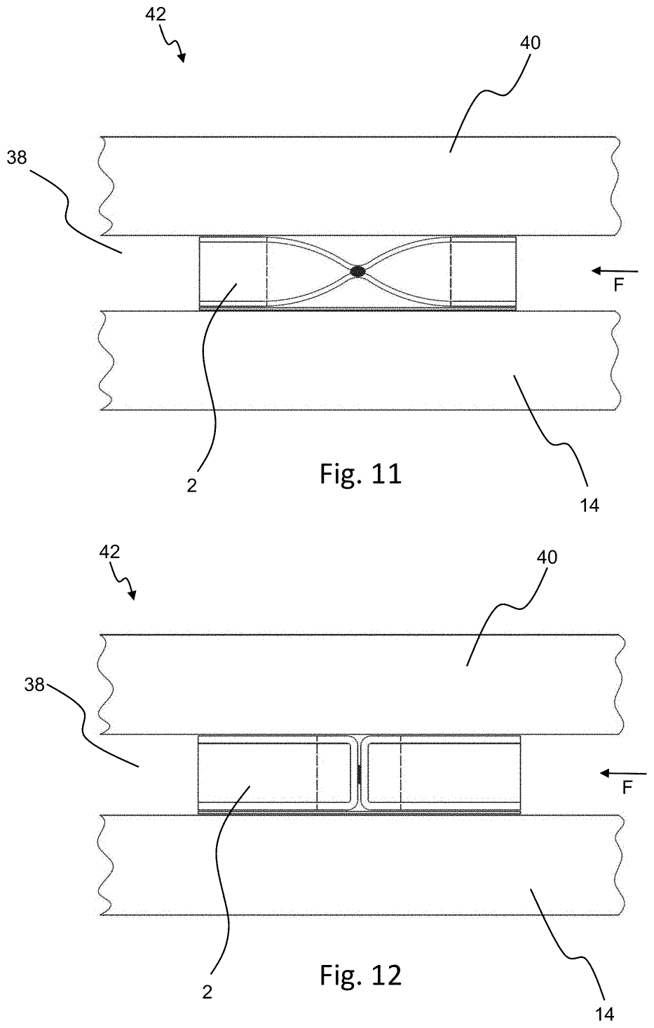

The sealing tape 2 illustrated here comprises a top surface 6, a bottom surface 8, and two side surfaces 10, which connect the top surface 6 and the bottom surface 8 to each other. The side surfaces 10 are substantially perpendicular to a functional direction F of the sealing tape, i.e., the direction in which the sealing tape, when in the later installed state (see FIG. 11), is intended to seal off a joint against the passage of air and/or against the diffusion of water vapor.

In the area of the bottom surface 8, an adhesive layer 12 is arranged, which, in the example shown here, is flat and serves to adhere the tape to a building component 14 (see FIG. 11) such as a frame profile of a window or door. The adhesive layer 12 is preferably configured as a double-sided adhesive tape and is adhered by its top surface to the adjacent areas of the sealing tape. The adhesive surface of the adhesive layer 12 serving to adhere the sealing tape to the building component 14 is oriented downward and is usually covered by a peel-off film or a peel-off paper, which can be removed before use. In the example shown here, it is also conceivable that the adhesive layer 12 could be configured with adhesive properties in the upward direction only in the areas in which it comes into contact with areas of the sealing tape.

The top surface 6 of the sealing tape 2 comprises a profile with a valley 16 in a middle area between the side surfaces 10 of the sealing tape 2. The interior space of the valley 16 is filled exclusively with air. In the area of the valley 16, the top surface 6 of the sealing tape 2 is curved. In the area of the side surfaces 10, the top surface 6 of the sealing tape 2 is substantially flat. The interior space of the valley 16 is defined as the space which is bounded by the curved part of the top surface 6 and an extension of the substantially flat section of the top surface 6 over the valley 16.

Because of the valley 16, which is filled only with air, the sealing tape 2 offers the advantage over sealing tapes with a base body with a rectangular cross section that, because of the relatively large quantity of air present in the middle area of the sealing tape 2, it has a greater thermal insulation effect. All of the other above-described embodiments of the sealing tape with at least one valley 16 in the top surface 6 or bottom surface 8 also offer this advantage.

In the area of the first (right) side surface 10, the sealing tape 2 comprises, in the fully expanded state, a first thickness h₁, which corresponds to the thickness h₂ of the second (left) side surface 10. At the vertex of the valley 16, however, the sealing tape 2, when in the fully expanded state, has a third thickness h₃, which is less than the first thickness h₁ and also less than the second thickness h₂. The reduced third thickness h₃ in the fully expanded state of the sealing tape 2 is obtained to at least some extent by a permanent compression and/or fusion of the material of the base body 4.

The bottom of the base body 4 comprises a profile with a lower valley 28, which is oriented toward the top surface 6 of the sealing tape 2 and which, in the area of the third thickness h₃, is opposite the valley 16 in the top surface 6.

The sealing tape 2 shown in FIG. 1 also comprises a continuous barrier structure 18 for reducing the diffusion of water vapor and/or the permeability to air in the functional direction F of the sealing tape, which structure extends from the top surface 6 to the bottom surface 8, passing at least partially through the area of the third thickness h₃.

In other embodiments, the thickness h₁ can also be different from the thickness h₂, as long as both thicknesses h₁, h₂ are greater than the thickness h₃.

In the embodiment shown in FIG. 1, the barrier structure 18 comprises several subsections, which together form the continuous barrier structure 18. First, the sealing tape comprises, on the top surface 6, a barrier layer 20. This barrier layer 20 extends from the first to the second side surface 10 and covers the base body 4 of the sealing tape 2 completely. The barrier layer 20 is preferably bonded to the base body 4 with an adhesive or laminated to it.

The sealing tape 2 also comprises an additional barrier layer 22 in the area of the bottom surface of the base body 4, which barrier layer also extends from the first to the second side surface 10 and preferably covers the base body completely. The barrier layer 22 is preferably bonded permanently to the base body with an adhesive or is laminated to it. The barrier layers 20, 22 thus form symmetrically configured boundaries of the base body 4 on its top and bottom surfaces.

A third component of the barrier structure 18 is the permanently compressed and/or fused section 24 of the sealing tape in the area of the valley 16. In this area, the barrier layer 20 arranged on the top surface 6, the barrier layer 22 arranged on the bottom surface 8, and the material of the base body 4 are jointly compressed and/or fused, as a result of which the reduced third thickness h₃ of the sealing tape is obtained. As a result of the compression and/or fusion of the various layers in this area, a seal-producing connection is produced between the upper barrier layer 20 and the lower barrier layer 22.

The compression and/or fusion can be achieved in this area by means of, for example, adhesive bonding after compression, by stitching, by lamination under simultaneous compression, or by partial melting (with or without compression). In all cases, the higher compression and/or the greater material density in the compressed/fused area ensures that, in this section 24, the sealing property of the sealing tape and/or the resistance to the diffusion of water vapor in the functional direction F is significantly increased. The material of the base body 4 can be compressed so strongly or fused to the materials of the barrier layers 20, 22 in such a way that it can no longer be distinguished visually from the barrier layers 20, 22.

The continuous barrier structure 18 formed by the upper barrier layer 20, the compressed/fused section 24, and the lower barrier layer 22 thus extends over the entire thickness of the sealing tape (except for the adhesive layer 12) and thus ensures a gap-free seal, adjusted to the desired degree, against the passage of air and/or the diffusion of water vapor over the entire thickness in the functional direction F.

In this embodiment, the barrier structure 18 begins from the first and second side surfaces 10 and extends along the top surface 6 of the sealing tape 2 to the area in the middle between the first and second side surfaces 10; it then proceeds from the top surface 6 down toward the bottom surface 8 of the sealing tape 2 and extends along the bottom surface of the base body 4 from the area in the middle between the first and second side surfaces 10 to the first and second side surfaces 10.

In this way, it is possible easily to produce a sealing tape 2 with a continuous barrier structure 18 without the need for the laborious process of introducing a plurality of sealing tape components into cuts in the sealing tape.

In the embodiment shown, it is also conceivable that the adhesive layer 12 does not extend continuously over the entire width of the sealing tape 2 but instead extends only in the form of strips in the areas in which it is to be adhered to the other elements of the sealing tape.

In FIG. 2, the sealing tape 2 according to FIG. 1 is shown in a configuration in which it has been wound up into a sealing tape roll 26. The sealing tape 2 is now in a (partially) compressed state, in which the top surface 6 and the bottom surface 8 of the sealing tape form substantially straight lines, or in which the valley 16 is much less pronounced than it is in the fully expanded state. The configuration as a sealing tape roll 26 is also preferred for all of the additional embodiments of the sealing tape according to the invention, and the same relationships pertain.

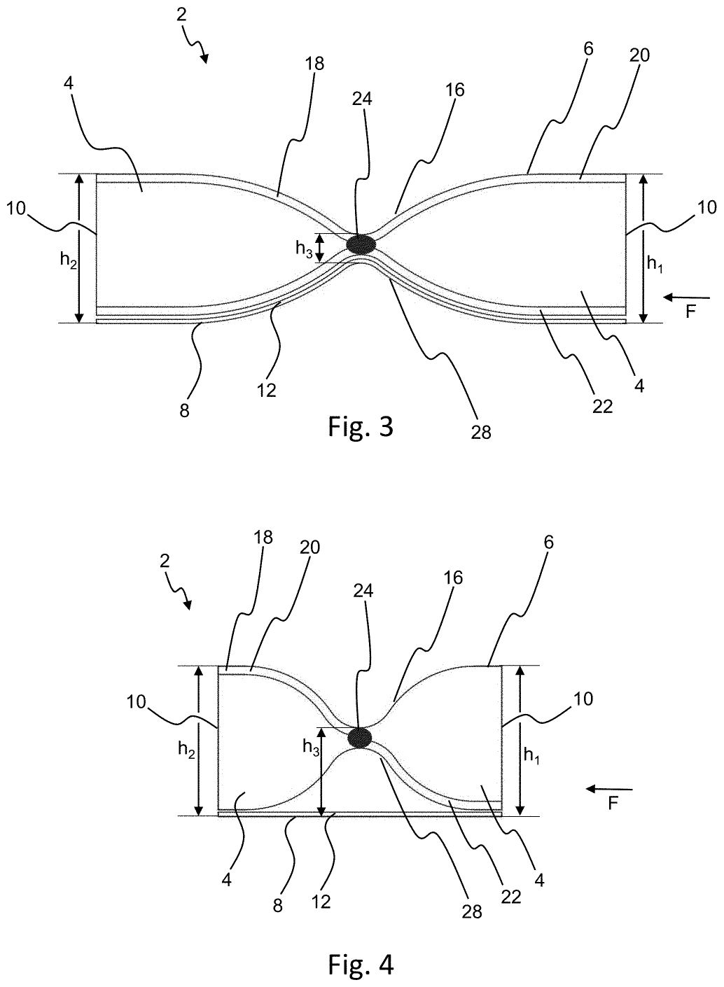

The sealing tape shown in FIG. 3 differs from the sealing tape of FIG. 1 in that the adhesive layer 12 adheres continuously to the lower barrier layer 22 and thus has a profile in the form of a hill, which corresponds to the profile of the bottom surface of the base body with the lower valley 28.

In the embodiment shown in FIG. 3, only the upper barrier layer 20, the base body 4, and the lower barrier layer 22 are compressed or fused together in the area of the compressed/fused section 24, whereas the adhesive layer 12 is applied afterwards as a separate strip to the sealing tape 2. It is also conceivable that the adhesive layer 12 could become a component of the compressed/fused section 24 and that it is also compressed and/or fused with the other components of the sealing tape 2 present in this area. In this case, the compression/fusion is not carried out until after the adhesive layer 12 has been applied.

The adhesive layer 12 can contribute additionally to the barrier structure 18. It is also conceivable that, in the embodiment according to FIG. 3, the lower barrier layer 22 could be omitted, in which case the adhesive layer 12 takes over the function of the lower barrier layer. It must then be ensured that the adhesive layer 12 has properties which reduce the passage of air or the diffusion of water vapor to the desired degree. In this case, the barrier structure 18 would be formed by the upper barrier layer 20, the compressed/fused section 24, and the adhesive layer 12.

Also in the embodiment according to FIG. 3, the barrier structure 18 extends along the top surface 6 of the sealing tape 2, beginning from the first and second side surfaces 10 and proceeding to the area between the first and second side surfaces 10, from which it then proceeds from the top surface 6 down toward the bottom surface 8 of the sealing tape 2 and then along the bottom surface of the base body from the area between the first and second side surfaces 10 to the first and second side surfaces 10.

The embodiment of the sealing tape 2 according to the invention shown in FIG. 4 differs from the embodiment of FIG. 1 in that the upper barrier layer 20 extends only from one side surface 10 to the compressed/fused section 24, and that the lower barrier layer 22 also extends only from the compressed/fused section 24 to one of the side surfaces 10, preferably to the side surface 10 of the sealing tape other than that from which the upper barrier layer 20 extends. This configuration is sufficient to form a continuous barrier structure 18, which is composed of the upper barrier layer 20, the compressed/fused section 24, and the lower barrier layer 22.

Formulated in general terms, the barrier structure 18, in the embodiment shown here, extends along the top surface 6 from the second side surface 10 (on the left) to the area between the first and the second side surfaces 10, from which it then proceeds from the top surface 6 down toward the bottom surface 8 of the sealing tape 2 and along the bottom surface of the at least one base body 4 from the area between the first and the second side surfaces 10 to the first side surface 10 (on the right). It is obvious that the barrier structure 18 can also, in a corresponding manner, begin from the first side surface 10, extend along the top surface 6, and then proceed along the bottom surface of the at least one base body 4 to the second side surface 10.

Alternatively, the barrier structure 18 on the top surface 6 extends from the first side surface 10 to the area between the first and second side surfaces 10, from which it then proceeds from the top surface 6 down toward the bottom surface 8 of the sealing tape and finally along the bottom surface of the at least one base body from the area between the first and second side surfaces 10 to the first side surface 10.

Because the entire thickness of the sealing tape 2 is covered over its complete cross section by these components, it is ensured that the air permeability or water vapor diffusion in the functional direction F of the sealing tape can be reduced to the desired degree.

It is also possible for only one of the two barrier layers 20, 22 to extend between a side surface 10 and the section 24 and for the other one of the two barrier layers 20, 22 to extend all the way between the two side surfaces 10.

The embodiment of the sealing tape 2 shown in FIG. 5 differs from the embodiment of FIG. 1 in that two compressed/fused sections 24 are provided across the width of the sealing tape 2. Between these sections 24, an area of the base body with a substantially oval cross section is arranged, which is preferably surrounded on the top and bottom surfaces by the barrier layers 20, 22.

It is also possible for more than two compressed/fused sections 24 to be provided across the width of the sealing tape. It is also conceivable in all of the embodiments that the compressed/fused section or sections 24 could be arranged asymmetrically across the width of the sealing tape.

The barrier structure 18 in the embodiment according to FIG. 5 is formed by the upper barrier layer 20, the lower barrier layer 22 (which can be replaced, optionally, by the adhesive layer 12), and the section 24. Alternatively, the barrier structure 18, in a sealing tape 2 configured in this way, can also be formed only by sections of the barrier layers 20, 22 as shown in FIG. 4.

In one embodiment of the sealing tape 2 according to the invention, the bottom of the base body can be substantially flat by comparison to the embodiment according to FIG. 5 and be adhered over its entire surface to the adhesive layer 12. The shape of the valleys 16, furthermore, can be substantially V-shaped, and the compressed/fused sections 24 can be located not in the middle area of the sealing tape 2, i.e., not in the middle with respect to thickness of the sealing tape, but rather in a lower area of the sealing tape. Such modifications of the valley 16 or of the compressed/fused section 24 are also conceivable for all of the other previously described embodiments. Even in the present embodiment, the shape of the valleys 16 can correspond to the shape in the other embodiments, e.g., those according to FIGS. 1 and 3-5. In this present example, furthermore, the lower barrier layer 22 can be omitted, if the adhesive layer 12 takes over its function.

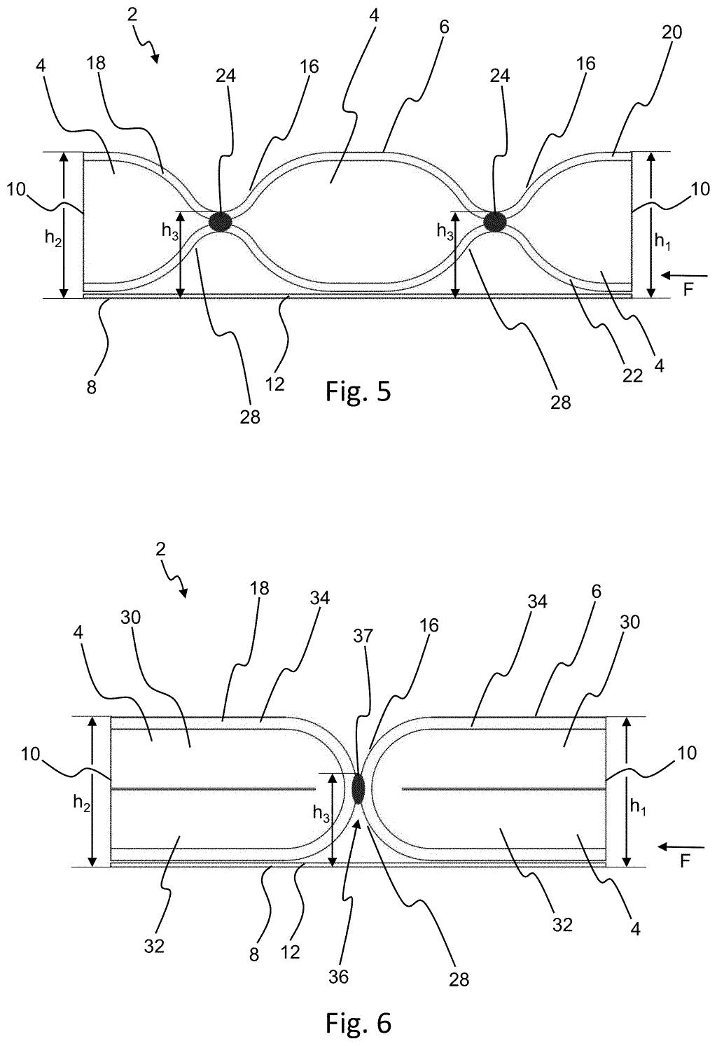

The embodiment of the sealing tape 2 according to the invention shown in FIG. 6 comprises two base bodies 4 of flexible foam capable of recovery after compression, which are preferably impregnated to delay their recovery and which are arranged next to each other in the functional direction F of the sealing tape 2.

The sealing tape 2 comprises a top surface 6, a bottom surface 8, and two side surfaces 10, which connect the top surface 6 and the bottom surface 8 to each other. The side surfaces 10 are substantially perpendicular to a functional direction F of the sealing tape 2, i.e., the direction in which the sealing tape 2, when in the installed state to be produced later, is intended to seal a joint against the passage of air and/or the diffusion of water vapor.

In the area of the bottom surface 8, an adhesive layer 12 is arranged, which, in the example shown here, is flat and serves to adhere the sealing tape to a building component 14 (see FIG. 12), such as a frame profile of a window or door. The adhesive layer 12 is preferably configured as a double-sided adhesive tape and adheres by its top surface to the adjacent areas of the sealing tape. The adhesive surface of the adhesive layer 12 serving to attach the sealing tape to the building component is oriented downward, i.e., facing away from the other components of the sealing tape 2, and is usually covered by a peel-off film or a peel-off paper, which can be removed before use. In the example shown here, it is also conceivable that the adhesive layer 12 could be configured so that it has adhesive properties only in the areas in which it comes in contact with areas of the sealing tape.

The top surface 6 of the sealing tape 2 comprises a profile with a valley 16 in a middle area of the sealing tape 2. The interior space of the valley 16 is filled exclusively with air. In the area of the first side surface 10 (on the right), the sealing tape 2, when in the fully expanded state, comprises a first thickness h₁, which corresponds to the thickness h₂ of the second side surface 10 (on the left). At the vertex of the valley 16, however, the sealing tape 2, when in the fully expanded state, has a third thickness h₃, which is less than the first thickness h₁ and also less than the second thickness h₂.

The area with the third thickness h₃ is formed in a transition area 36 between the two base bodies 4. In the example shown here, each of the two base bodies 4 is obtained by bending a molded body with an originally rectangular cross section, wherein a first or upper leg 30 of the base body 4 is bent over by 180° with respect to a second or lower leg 32 of the base body 4. The bending site is arranged in the area 36 of the transition to the other base body 4; and, as a result of the bending process, the foam material of the base body 4 is compressed into itself in the area of the bending site.

The first and second legs 30, 32 can be adhered to each other at their facing surfaces; they are preferably bonded together by means of an adhesive or laminated to each other. As a result, an substantially horizontal adhesion surface is obtained between the legs 30, 32.

Each of the two base bodies 4 comprises a covering 34, which surrounds it on the top surface, the bottom surface, and the side facing the other base body 4. Depending on the stiffness of this covering 34, the covering 34 can in each case contribute additionally to the compression of the material of the base body 4 in the area of the bending site. The adhesive layer 12 is adhered permanently to the two coverings 34 along their bottom surface.

It is preferred that the covering 34 form a barrier structure 18, which fulfills the same requirements as the barrier structure 18 described previously on the basis of FIG. 1. Each covering 34 forms its own continuous barrier structure 18, which, considered across the width of the sealing tape 2, covers the entire thickness of the sealing tape 2 and thus can reduce the air permeability or the passage of water vapor in the functional direction F of the sealing tape to the desired degree. The barrier structure 18 thus proceeds at least from one of the two side surfaces 10, i.e., either from the first or second side surface, continues along the top surface 6 and through the transition area 36, and finally extends along the bottom surface of the same base body back to the same side surface 10, i.e., either back to the first or back to the second side surface.

The two adjacent base bodies 4 in the present case are permanently adhered to each other, e.g., by means of an adhesive layer 37, in the transition area 36 via the intermediate presence of the associated sections of the coverings 34. The coverings 34 of the two base bodies 4, however, can also be fused directly together. An adhesive layer 37 of this type or the adhesive bonding of the coverings 34 can also contribute to the barrier structure 18.

The end result is that, in the area of the reduced third thickness h₃, an substantially V-shaped valley 16 is formed in the area of the top surface 6 of the sealing tape, and an additional V-shaped valley 28 is formed in the area of the bottom surface 8 of the sealing tape, opposite the valley 16.

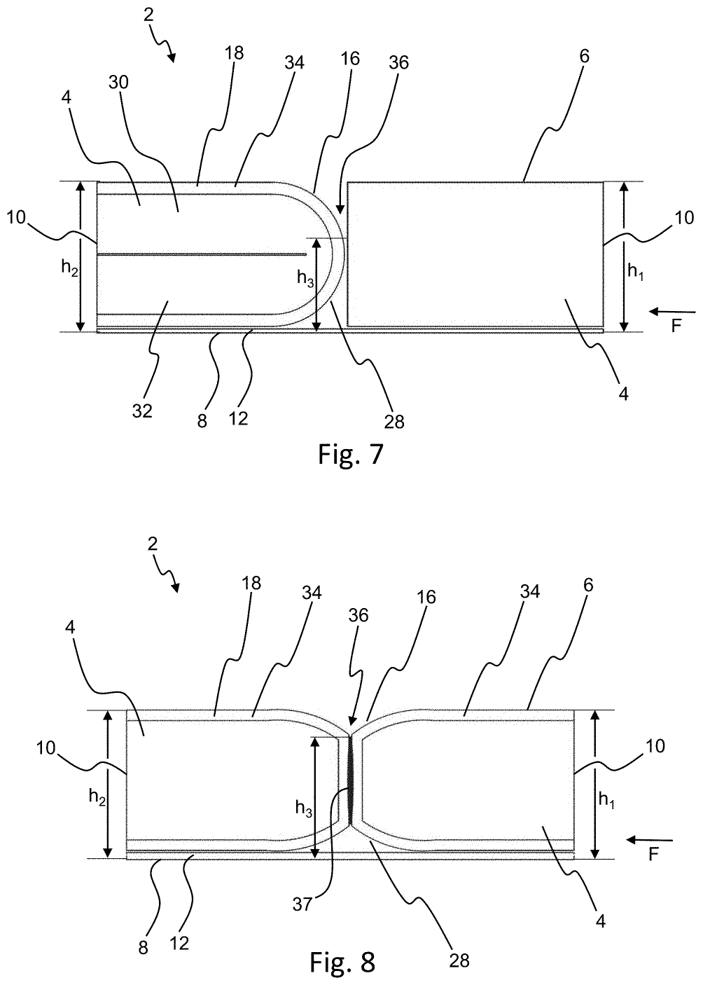

The embodiment of the sealing tape 2 according to the invention shown in FIG. 7 differs from the embodiment of FIG. 6 in that only one of the base bodies 4 corresponds to one of the two base bodies 4 of FIG. 6. The other base body 4 is also a base body of flexible foam, but it represents a pre-cut part with a rectangular cross section. The pre-cut part can also have some other geometric shape.

The continuous barrier structure 18 is formed in this case only by the covering 34 of the first base body 4. In the transition area 36, the two base bodies 4 merely rest against each other, but they can also be adhered to each other, as described on the basis of FIG. 6.

The thicknesses of the two base bodies 4 are preferably the same, but they can also be different. In the transition area 36, it is preferred that the third thickness h₃ be less than that in the area of each of the two side surfaces 10 of the sealing tape 2. The arrangement of the two base bodies 4 with respect to the functional direction F in FIG. 7 can also be reversed. It is also conceivable that, on the side of the free lateral surface of the rectangular base body 4, an additional base body 4 with a covering 34 could be arranged, preferably a mirror image of the base body 4 already shown in FIG. 7.

The embodiment of the sealing tape 2 according to FIG. 8 differs from the embodiment of FIG. 6 in that each of the two base bodies 4 consists of a pre-cut part with a rectangular cross section and is not bent over. The compression of the two base bodies 4 near the transition area 36 is therefore obtained exclusively by the adhesion of the two coverings 34 in the transition area 36 and by the stiffness of the coverings 34. To form the valley 16 and possibly the valley 28, it is then essential that the adhesive layer 37 between the coverings 34 have a lesser thickness than the first or second thickness h₁, h₂ at the side surfaces 10 of the sealing tape. Because of the stiffness of the covering 34, each base body 4 will then be more highly compressed near the transition area 36 than it is in the area of the side surface 10 when fully expanded. In this embodiment as well, the barrier structure 18 is formed by at least one covering 34 and possibly by the adhesive layer 37 also.

It is also possible to combine a base body configured as in FIG. 8 with a conventional base body 4 with a rectangular cross section without a covering 34.

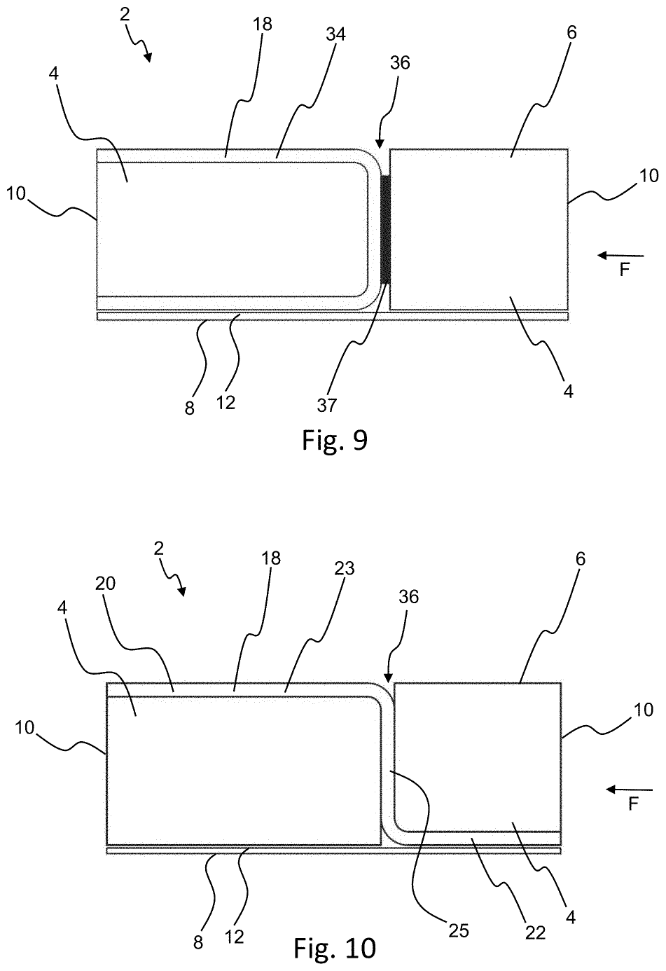

The embodiment of the sealing tape 2 according to FIG. 9 differs from the embodiment of FIG. 7 in that each of the two base bodies consists of a pre-cut part with a rectangular cross section and is not bent over. The one base body 4 (on the left in FIG. 9) corresponds substantially to one of the two base bodies 4 according to FIG. 8 and comprises a covering 34, which forms at least part of the barrier structure 18. The other base body 4 (on the right in FIG. 9) corresponds substantially to the pre-cut part of flexible foam with a rectangular cross section according to FIG. 7, but it can also have some other geometric shape. The two base bodies 4 can be permanently bonded to each other in the transition area 36 by means of, for example, an adhesive layer 37. The two base bodies 4, however, can also be connected to each other only by means of the adhesive layer 12 in the area of their associated bottom surfaces.

In contrast to FIG. 8, the covering 34 or its adhesion to the other base body 4 in this case produces no significant compression of the base body 4 in or near the transition area 36. Correspondingly, no significant valleys 16, 28 are formed in the top and bottom surfaces of the sealing tape 2. As a result, the result is achieved that the sealing tape 2, when in the installed state, rests as completely as possible over its entire width against a building component 14 and the wall 40. The pressure exerted by the sealing tape 2 on the wall is then substantially constant over the width of the sealing tape 2.

To increase the sealing action of the sealing tape 2, however, at least the covered base body 4 in this embodiment can also be compressed to any desired degree, as previously described in connection with the other embodiments, this compression being achieved, for example, by means of the covering 34.

The sealing tape according to the invention shown in FIG. 10 comprises two substantially rectangular base bodies 4 of flexible foam. The barrier structure 18 in this case is formed as a continuous, preferably one-piece barrier layer 23, which extends along the top surface 6 of the sealing tape 2, proceeds from the top surface 6 down to the bottom surface 8 of the sealing tape 2, and then extends along the bottom surface of at least one of the two base bodies. Here the barrier structure 18 or the barrier layer 23 begins from the second side surface 10 (on the left), proceeds along the top surface 6 of the sealing tape 2 and then along the facing side surfaces of the base bodies 4 in the transition area 36, from which it then proceeds to the bottom surface 8 of the sealing tape 2, where it extends along the bottom surface of the one base body 4 to the first side surface 10 (on the right). It is obvious that the barrier structure 18 could also begin from the first side surface 10, extend along the top surface 6, and proceed along the bottom surface 8 to the second side surface 10.

The continuous barrier layer 23 can be formed in part by a barrier layer 20 on the top surface 6 of the sealing tape 2 and in part by a barrier layer 22 on the bottom surface of at least one base body 4, as described on the basis of FIGS. 1 and 3-5. The barrier layers 20, 22 can extend either only from one of the two side surfaces 10 to the transition area 36 or over the entire width of the sealing tape 2.

In the transition area 36, another barrier layer section 25 is provided, which connects the two barrier layers 20, 22 to each other. The barrier layer section 25 along the facing side surfaces of the base bodies 4 is preferably substantially parallel to the side surfaces 10 and can be adhered to at least one of the two base bodies 4, preferably to both base bodies 4.

The barrier layer section 25 can be formed as an integral part of the barrier layers 20, 22 and can preferably be made of the same material as they are. The barrier layer section 25, however, can also be made of a different material, such as a film or an adhesive layer, or it can be formed by the fusion of the foam of one of the two base bodies along the corresponding side surface. The barrier layers 20, 22 and the barrier layer section 25 should then be bonded together to produce the seal.

In general, the continuous barrier layer 23 and the barrier layer section 25 can, within the scope of the invention, have the same properties and be made of the same materials as those described herein for the barrier layers 20, 22 and the covering 34.

The two base bodies 4 can be bonded together by means of the barrier layer section 25, e.g., bonded by means of an adhesive or laminated together. Alternatively, the base bodies 4 can merely hold the barrier layer section 25 loosely between them and be bonded permanently together by means of the adhesive layer 12. The adhesive layer 12 can also take over the function of the lower barrier layer 22, which can then be omitted accordingly.

In the embodiments according to FIGS. 6-10, more than two base bodies 4 can also be arranged next to each other appropriately and bonded together in each case.

There are many different possible ways of combining or modifying the individual embodiments. All such combinations are intended to be disclosed herewith to the extent that they fall under the attached claims.

FIG. 11 shows the sealing tape 2 of FIG. 1 in an installed state. In a section 42 of a building, the sealing tape 2 is arranged in a joint 38 in a partially compressed installation state between a building component 14, especially a frame profile of a window or door, and a wall 40 and thus seals the joint 38. As indicated by the broken lines, the top surface 6 of the sealing tape 2 rests against the wall 40 in the area of the side surfaces 10 of the sealing tape, whereas, at least in the area of the original third thickness h₃ and in the adjacent areas (between the broken lines), the top surface 6 does not rest against the wall 40. It is also conceivable, however, that the third thickness h₃ could be considerably greater and that the top surface 6 of the sealing tape could thus also rest against the wall 40 in the area of the original third thickness h₃, in which case, however, the pressure exerted here will be less than that present in the area of the side surfaces 10 of the sealing tape.

FIG. 12 shows the sealing tape 2 of FIG. 8 in a corresponding installation situation. In this case, the sealing tape 2 is compressed between the building component 14 and the wall 40 in the section 42 of the building to such a pronounced degree that the top surface 6 rests against the wall 40 even in the area of the original third thickness h₃ as well as in the adjacent areas (between the broken lines), although the pressure exerted on the wall is less here than in the area of the side surfaces 10 of the sealing tape.

If, however, the base bodies 4 of the sealing tape 2 shown in FIG. 12 are configured like the covered base bodies 4 according to FIG. 9 or if, instead of the illustrated sealing tape 2, the sealing tape 2 according to FIG. 9 is used, the top surface 6 of the sealing tape will rest against the wall 40 substantially over the entire width of the sealing tape 2. The pressure exerted by the sealing tape 2 on the wall will then be substantially constant over the entire width. A deviation, however, can occur in the transition area 36, but it will be negligible because of the small dimensions of the adhesive layer 36 or similar bonding means.

1. A sealing tape comprising at least one base body of flexible foam capable of recovery after compression,
wherein the sealing tape comprises a top surface, a bottom surface, and first and second side surfaces, which connect the top surface and the bottom surface to each other, wherein the side surfaces are substantially perpendicular to a functional direction of the sealing tape;
wherein an adhesive layer for bonding to a frame profile of a window or door is arranged in an area of the bottom surface; and
wherein the sealing tape comprises a continuous barrier structure for reducing the permeability to the diffusion of water vapor and/or the permeability to air in the functional direction, which barrier structure extends along the top surface from at least one of the first and second side surfaces to an area between the first and second side surfaces, from where it then proceeds from the top surface to the bottom surface of the sealing tape and finally extends along a bottom surface of the at least one base body from the area between the first and second side surfaces to at least one of the first and second side surfaces.

2. The sealing tape according to claim 1, wherein the barrier structure extends along the top surface from the first side surface to the area between the first and second side surfaces, from where it then proceeds from the top surface to the bottom surface of the sealing tape and finally extends along the bottom surface of the at least one base body from the area between the first and second side surfaces to the second side surface.

3. The sealing tape according to claim 1, wherein the barrier structure extends along the top surface rom the first side surface to the area between the first and second side surfaces, from where it then proceeds from the top surface to the bottom surface of the sealing tape and finally extends along the bottom surface of the at least one base body from the area between the first and second side surfaces to the first side surface.

4. The sealing tape according to claim 1, wherein the barrier structure extends along the top surface from the first and from the second side surface to the area between the first and second side surfaces, from where it then proceeds from the top surface to the bottom surface of the sealing tape and finally extends along the bottom surface of the at least one base body from the area between the first and second side surfaces to the first and second side surfaces.

5. The sealing tape according to claim 1, wherein the top surface of the sealing tape comprises a profile with at least one valley, wherein the sealing tape, when in a fully expanded state, comprises a first thickness in an area of the first side surface, a second thickness in an area of the second side surface, and a third thickness in an area between the first and second side surfaces, which third thickness is less than the first thickness and less than the second thickness, and wherein an interior space of the valley, in the fully expanded state of the sealing tape, is filled exclusively with air;
wherein the barrier structure proceeds from the top surface to the bottom surface of the at least one base body by extending through the area of the third thickness.

6. The sealing tape according to claim 5, wherein the lesser third thickness in the fully expanded state of the sealing tape is obtained at least in part by a permanent compression and/or fusion of the foam of the at least one base body; and
wherein the barrier structure is formed at least in part by a permanently compressed and/or fused section of the at least one base body.

7. The sealing tape according to claim 1, wherein the sealing tape comprises two base bodies, which are arranged next to each other in the functional direction of the sealing tape, wherein, in a transition area between the two adjacent base bodies, the barrier structure extends at least partially from the top surface to the bottom surface of the sealing tape.

8. The sealing tape according to claim 7, wherein the two base bodies are configured as originally separate units, which are adhered to each other in the transition area by the barrier structure.

9. The sealing tape according to claim 7, wherein the barrier structure is configured as a continuous barrier layer, which extends along the top surface of the sealing tape, proceeds from the top surface to the bottom surface of the sealing tape, and finally extends along the bottom surface of at least one of the at least two base bodies.

10. The sealing tape according to claim 7, wherein at least one of the base bodies comprises a covering, which surrounds the base body on the top surface, the bottom surface, and a side facing an adjacent base body, wherein the covering forms part of the barrier structure or the entire barrier structure.

11. The sealing tape according to claim 1, wherein the barrier structure is formed in part by a barrier layer arranged on the top surface of the at least one base body.

12. The sealing tape according to claim 1, wherein the barrier structure is formed in part by a barrier layer arranged on the bottom surface of the at least one base body.

13. The sealing tape according to claim 1, wherein the barrier structure is formed in part by the adhesive layer.

14. A sealing tape roll comprising a sealing tape,
wherein the sealing tape comprises at least one base body of flexible foam capable of recovery after compression,
wherein the sealing tape comprises a top surface, a bottom surface, and first and second side surfaces, which connect the top surface and the bottom surface to each other, wherein the side surfaces are substantially perpendicular to a functional direction of the sealing tape;
wherein an adhesive layer for bonding to a frame profile of a window or door is arranged in an area of the bottom surface;
wherein the sealing tape comprises a continuous barrier structure for reducing the permeability to the diffusion of water vapor and/or the permeability to air in the functional direction, which barrier structure extends along the top surface from at least one of the first and second side surfaces to an area between the first and second side surfaces, from where it then proceeds from the top surface to the bottom surface of the sealing tape and finally extends along a bottom surface of the at least one base body from the area between the first and second side surfaces to at least one of the first and second side surfaces. and
wherein the sealing tape in the sealing tape roll is wound up in a compressed state in which the top surface and the bottom surface of the sealing tape extend in substantially straight lines.

15. A building section comprising a wall and a building component inserted into an opening in the wall, wherein a sealing tape in a partially compressed installation state is arranged in a joint between the building component and the wall and seals the joint,
wherein the sealing tape comprises at least one base body of flexible foam capable of recovery after compression,
wherein the sealing tape comprises a top surface, a bottom surface, and first and second side surfaces, which connect the top surface and the bottom surface to each other, wherein the side surfaces are substantially perpendicular to a functional direction of the sealing tape;
wherein an adhesive layer for bonding to a frame profile of a window or door is arranged in an area of the bottom surface;
wherein the sealing tape comprises a continuous barrier structure for reducing the permeability to the diffusion of water vapor and/or the permeability to air in the functional direction, which barrier structure extends along the top surface from at least one of the first and second side surfaces to an area between the first and second side surfaces, from where it then proceeds from the top surface to the bottom surface of the sealing tape and finally extends along a bottom surface of the at least one base body from the area between the first and second side surfaces to at least one of the first and second side surfaces, and
wherein, in the partially compressed installed state, the top surface of the sealing tape rests against the wall.
